(19) United States
(12) Patent Application Publication
(10) Pub. No.: US 2005/0022878 A1
(43) Pub. Date: Feb. 3, 2005

(54) Intruder resistant vent structure

(76) Inventor: Michael Dennis Erinakes, Burleson, TX (US)

Correspondence Address: Steven B. Leavitt, 9914 Waterview Parkway, Rowlett, TX, 75089, US

(21) Appl. No.: 10/629,663

(22) Filed: Jul. 28, 2003

(51) Int. Cl. F17C 13/06

(52) U.S. Cl. 137/587

(57) ABSTRACT

The vent structure comprises a durable material wherein a tortious pathway is provided for gas to flow into and out of a storage tank. The tortious pathway is defined by a plurality of baffles that depend or extend from the inner surface of the vent structure. Further protection of the storage tank contents is provided by employing mesh screen covers over the openings to the vent structure and to the storage tank. Unauthorized disassembly of the vent structure is assisted by using support columns that extend from the cover to the bottom of the vent structure. A terminal portion of each support column may be adapted to pass through a portion of the vent structure and receive a lock. Thereby, an intruder resistant vent structure deters unauthorized access to a storage tank which is particularly useful for protecting a water storage tank.

### BACKGROUND OF THE INVENTION

1. Technical Field

The present invention relates to vents for water-storage tanks. More particularly, the invention relates to an intruder resistant vent structure for application onto water storage tanks.

2. Description of Related Art

Storage tanks are often provided with a vent to allow the gas pressure within the tank to equalize to the ambient atmospheric pressure. Particular to water storage tanks for drinking water, it is desirable to prevent any unwanted matter or persons from gaining entry into the storage tank through the vent opening in the storage tank. When water storage tank vents are not properly protected or their protection device fails, insects, birds, other small animals, and trash may gain entry into the drinking water within the storage tank creating a potential health hazard. To prevent this, vent covers are employed over the vent openings.

Common vent covers employed with water storage tanks are known to have an enlarged upper cover having a gradually sloping top to drain water away from entry into the tank. This allows air to enter into and from the storage tank vent opening. A mesh screen is often attached with support elements around the vent cover's opening to prevent the entry of insects into the tank interior. The difficulty with this type of vent cover is that the screens and other components of prior art vent covers are known to fail due to the corrosive environment often found within water storage tanks. Also, animals such as birds or rodents may be able to penetrate screen coverings, especially those that have been weakened due to corrosion. When screen coverings are compromised, unwanted intruders gain access into the interior of the water storage tank.

Another serious concern with protecting drinking water is from the threat of terrorism. Few prior art vent covers, if any, provide little protection from determined individuals wishing to gain access to the interior of a water storage tank. Therefore, a vent cover that can provide protection from all types of unwanted intruders, including people, is desired Further, the desired vent cover should be designed to include a multiplicity of deterrents to protect the contents of a storage tank.

### SUMMARY OF THE INVENTION

A vent structure according to the present invention deters unauthorized access to a storage tank preferably for water. With water storage tanks, a vent is provided so that atmosphere within the storage tank can communicate with the ambient atmosphere surrounding the storage tank to substantially prevent gas in the void volume of the tank from being compressed or expanded. However, providing a vent to the water storage tank also provides an access point into the tank for unwanted intruders. With the vent structure described herein, the vent opening into a storage tank can be protected.

The vent structure is formed with a bottom plate having a centrally disposed tank opening for attachment to a vent of a storage tank. In a preferred arrangement, a flange may first be affixed to a protruding vent of the storage tank to which the bottom plate may then be attached to the flange. The tank opening allows gaseous flow between an atmosphere in the water storage tank and an atmosphere within the vent structure when connected to the water storage tank. A cover is then affixed above and to the bottom plate to form the vent structure housing. A vent opening formed through the bottom plate allows gaseous flow between the atmosphere of the vent structure and the ambient atmosphere surrounding the water storage tank. A tortuous pathway is disposed within the vent structure between the vent opening and the tank opening to allow gaseous communication between the water storage tank atmosphere and the ambient atmosphere surrounding the storage tank. Further, the tortuous pathway is formed with a plurality of baffles having at least one baffle that extends upward from the bottom plate toward the cover and at least one baffle that depends downward from the cover toward the bottom plate. As additional protection, a mesh screen covering may be affixed to the openings to the tank and to the vent structure.

To provide further support, the vent structure may include one or more support columns positioned within the vent structure between the vent opening and the tank opening. Each support column extends between the cover and the bottom plate. Preferably, each support column depends from the cover and extends down and through to the bottom plate. At least one of support columns, preferably at least two, has a terminal end that is received and passed through a receptacle in the vent structure. The terminal end then protrudes through the receptacle to an exterior portion of the vent structure whereby a locking mechanism such as a key or combination lock may be affixed to the protruding terminal end. To further protect against unauthorized access, a guard for protecting the locking mechanism extends outward from the bottom plate to form a barrier around the locking mechanism.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is an exploded perspective view of an intruder resistant vent structure for use on a water storage tank;

FIG. 2 is a side cross sectional view of the vent structure of FIG. 1 shown affixed to a water storage tank;

FIG. 3 is a bottom perspective view of the cover of the vent structure of FIG. 1;

FIG. 4 is a top planar view of the base of the vent structure of FIG. 1; and

FIG. 5 is a bottom perspective view of the flange of the vent structure of FIG. 1.

### DETAILED DESCRIPTION

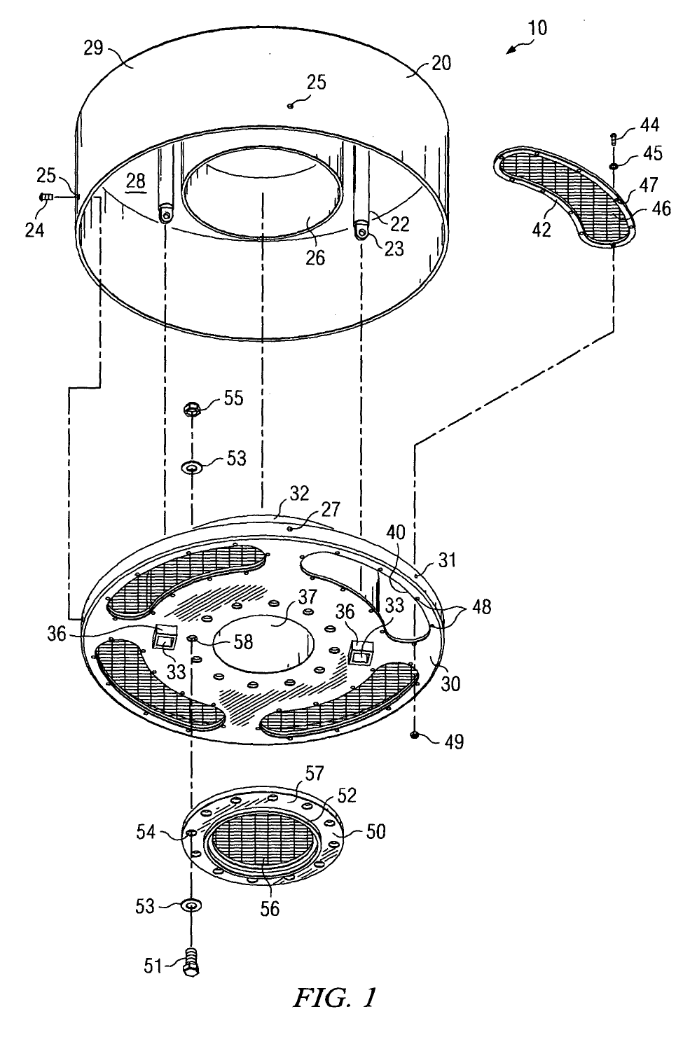

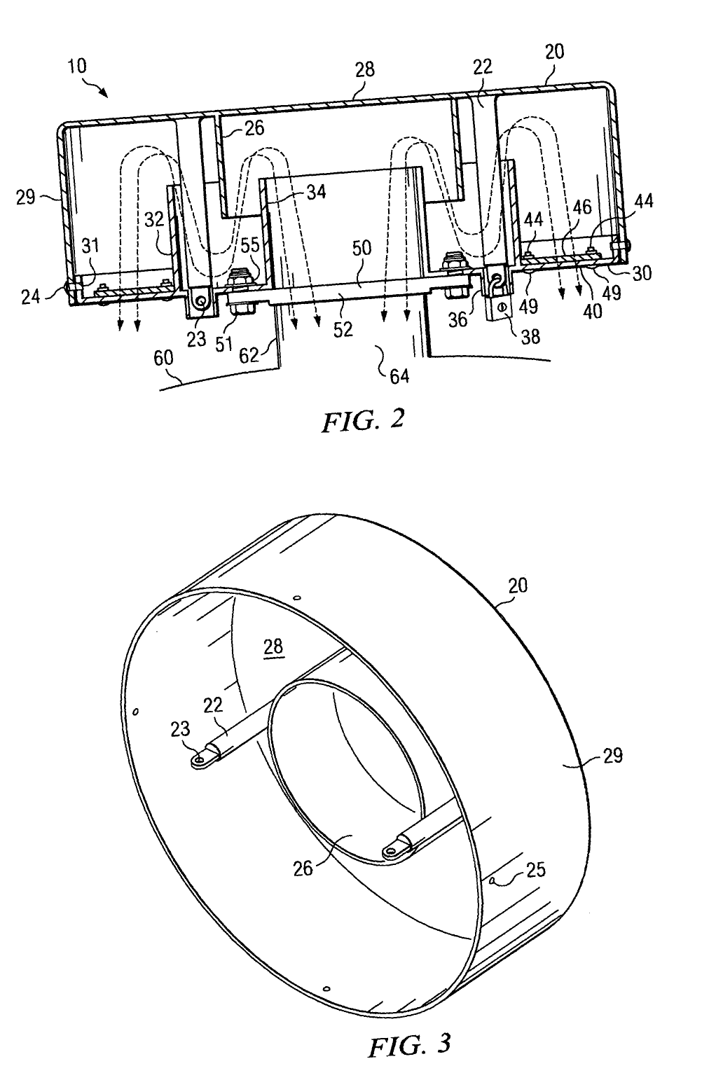

Referring to FIGS. 1 and 2, a vent structure 10 shown in accordance with a preferred embodiment of the present invention is constructed to prevent unauthorized access by intruders, which may include rain, animals, leaves, trash, people, and other foreign matter, into a container to which vent structure 10 has been affixed. Particularly, vent structure 10 is designed to be employed with water storage tanks such as water tank 60. However, other containers such as chemical storage tanks, transport vessels, and other storage devices requiring venting may employ the vent structure of the present invention. With water storage tanks, venting is provided to allow the open volume or air space within the tank to change without affecting its internal air pressure. Thereby, the flow of water into and out of the tank is not impeded by a contained mass of air within the tank.

Vent structure 10 generally comprises a cover 20, a bottom plate 30, and a flange 50. When assembled, vent structure 10 has a tortuous venting path formed with the use of baffles 26, 32, and 34, which does not substantially impede the flow of gases into or out of a tank. However, this tortuous venting path does deter the entry of undesired matter. Vent structure 10 is cylindrically shaped with one end sealed and the other end partially open for venting and for engaging a storage tank. While shown having a generally cylindrical shape, vent structure 10 may comprise other shapes such as, for example, a box.

The components of vent structure 10 may be comprised of any material that is corrosion resistant and durable such as aluminum, stainless steel, steel, and fiberglass. In a preferred embodiment described herein, cover 20, bottom plate 30, and their depending parts comprise, unless noted otherwise, aircraft aluminum that has a corrosion resistant coating applied thereto. Coated aircraft aluminum is preferred because of its resistance to corrosion, durability, and cost.

FIG. 3 shows an additional view of cover 20 having a top 28 and a peripheral edge 29. As cover 20 is constructed to engage bottom plate 30, one or more support columns 22 are provided within an interior portion of vent structure 10 to assist in supporting cover 20. Each support column 22 has an opening 23 located at about its terminal end. Support columns 22 depend from top 28 toward bottom plate 30 wherein columns slots 33 are provided within bottom plate 30 for receiving the terminal ends of support columns 22. Once assembled, openings 23 pass through columns slots 33 and extend beyond the external underside of bottom plate 30 to provide for the application of one or more locks 38 if desired. For additional security, an optional guard cover 36 is provided on the underside of bottom plate 30 around the periphery of each column slot 33. Guard cover 36 extends outward from the underside of bottom plate 30 and protects any locking mechanism such as locks 38 that are subsequently attached to opening 23. While the terminal ends of support columns 22 are shown having openings 23, an alternative design of the terminal ends may employ flattened ends for engaging the internal top side of bottom plate 30. In another alternative embodiment not shown, the support columns may stem upward from bottom plate 30 toward top 28.

In addition to support columns 22 and locks 38, one or more bolts 24 may be used to secure cover 20 to bottom plate 30. In application, each bolt 24 is inserted through a cover bolt hole 25 and is received by bottom plate bolt hole 27 located on bottom plate peripheral edge 31. To retain bolt 24 in position after insertion through holes 25 and 27, a nut (not shown) is applied to the end of bolt 24. In addition to or in replacement of bolts 24, other fasteners, such as rivets, adhesives, or welding may be employed.

Bottom plate 30 has at least one vent opening 40 for allowing air to pass into or out of vent structure 10. As shown in further detail in FIG. 4, a plurality of vent openings 40 are provided in a preferred embodiment. Each opening 40 is disposed between edge 31 and bottom cover outer baffle 32. Vent opening screen 46 is affixed to the vent opening screen frame 42 to provide a first deterrent to prevent any unwanted foreign matter from entering into vent structure 10 and, subsequently, water tank 60. Screen 46 is preferably comprised of a fine mesh and is comprised of stainless steel for its strength and corrosion resistance. Frame 42 is also preferably comprised of stainless steel for its strength and corrosion resistance. With the placement of vent openings 40 on the underside of vent structure 10, the opening into vent structure 10 is less likely to become obstructed with debris such as leaves and trash.

Securing frame 42 and vent opening screen 46 to the top portion of bottom plate 30 are one or more bolts 44. Therein, each bolt 44 is inserted through an optional washer 45, then through one of the screen bolt holes 47 located along vent opening frame 42. The bolt 44 is then subsequently inserted through a corresponding screen bolt hole 48 in bottom plate 30. Once in position, each bolt 44 is secured into position with the preferable use of a screen bolt nut 49 affixed to the terminal end of each bolt 44. Furthermore, a plurality of bolts applied about the circumference of frame 42 is preferably used to retain screen 46 in position upon bottom plate 30 to provide increased intruder protection. Bolts 44, washers 45, and nuts 49 are preferably comprised of stainless steel for strength and durability. In addition to or in replacement of bolts 44 and associated hardware, other fasteners, such as rivets, adhesives, or welding, may be employed to secure frame 42 and vent opening screen 46 to bottom plate 30.

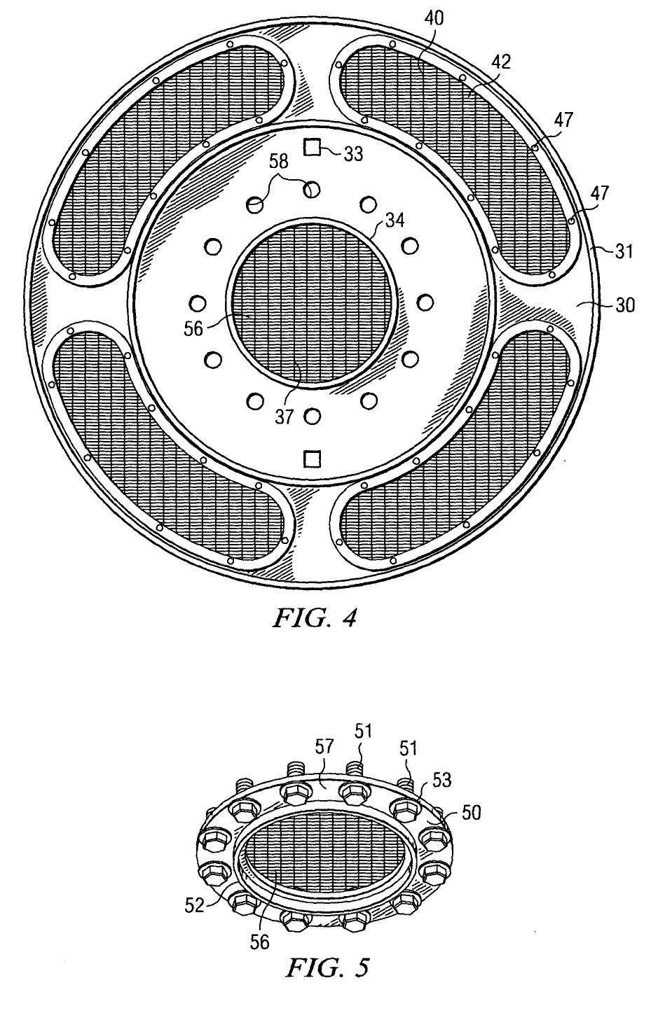

To affix the vent structure 10 to a water tank, a flange 50, as shown in further detail in FIGS. 2 and 5, is mounted onto a tank vent opening such as tank vent 62. Flange 50 is preferably comprised of cast iron and has an optional screen 56, which is preferably comprised of stainless steel for strength and durability. Screen 56 is affixed to inner peripheral edge 52 of flange 50 so that screen 56 is in about the same plane as the top of bottom plate 30. As shown in FIGS. 1, 4, and 5, screen 56 provides an additional intruder barrier between vent structure 10 and water tank 60. Thereby, opening 37 is covered by screen 56 upon attaching bottom plate 30 to flange 50. For robust attachment of flange 50 to tank vent neck 64, inner peripheral edge 52 extends beyond planar flange edge 57 toward water tank 60. Flange 50 is then attached to tank vent neck 64 with welding, adhesives, and/or other fasteners to form a seal. Preferably, an essentially complete seal of edge 52 to tank vent neck 64 is desired to prevent intruders from bypassing vent structure 10 to obtain access to the interior of water tank 60.

Flange 50 is adapted for mating with the underside of bottom plate 30 at about the bottom plate tank opening 37, which is disposed centrally in bottom plate 30. To retain bottom plate 30 to flange 50, one or more flange bolts 51 are provided for insertion through flange bolt holes 54 and then through a corresponding bottom plate flange bolt hole 58. Flange bolt holes 54 are formed radially through and along the planar flange edge 57 for alignment with bottom plate flange bolt holes 58, which are disposed radially about opening 37. To render the attachment of bottom plate 30 to flange 50 robust, a plurality of flange bolt holes 54 and bottom plate flange bolt holes 58 are provided around the circumference of opening 37 for the placement of flange bolts 51 therethrough. In application, each flange bolt 51 is inserted through a flange bolt washer 53, flange bolt hole 54, bottom plate flange bolt hole 58, and then another flange bolt washer 53. A flange bolt nut 55 is applied to the terminal end of each flange bolt 51 to retain it in the desired position. Bolts 51, washers 53, and nuts 55 are preferably comprised of stainless steel for strength and durability. In addition to or in replacement of bolts 51 and associated hardware, other fasteners, such as rivets, adhesives, or welding, may be employed to secure bottom plate 30 to flange 50.

Once assembled and positioned atop water tank 60, venting may proceed as shown in FIG. 2. For the occurrence of atmospheric air venting into water tank 60, a current of air passes through vent opening 40 and vent opening screen 46 up toward cover top 28. The current of air then passes down toward bottom plate 30 passing over baffle 32. Thereafter, the current of air passes up between baffles 26 and 34 toward cover top 28. Finally, the current of air passes down toward and through flange screen 56 for entrance into water tank 60 via water tank vent 62. For the occurrence of air venting out from water tank 60 into the atmosphere, the venting process described above is reversed.

With the use of a vent cover made in accordance with the present invention such as vent structure 10, a water tank can be adequately ventilated while restricting access to the interior of the tank. Unlike prior art vent covers for water tanks, the durable and robust venting structure 10 provides sufficient airflow into and out of the tank while providing improved security.

Particularly with the public's concern and need for safe and adequate sources of water, a protective device such as the present invention is of significant importance. This is because vent structures made in accordance with the present invention provide resistance to intruders whether they are naturally occurring or not. For naturally occurring intruders such as rain, animals, leaves, and other foreign matter, the screens, tortuous air path, and other features of the present invention will prevent their entrance into the interior of the water tank via the protected tank vent.

For intruders such as terrorists, vandals, or other unwanted trespassers, the screens, tortuous air path, locks, robustness and durability of the construction materials, and others features of the present invention, will prevent or at least deter trespassers from introducing unwanted matter into the water tank protected by the vent structure. If, for example, a trespasser wanted to introduce a harmful chemical into the water tank via a hose, a vent opening screen 46 would prevent entry of the hose into vent structure 10. If the trespasser attempted to spray up into the vent structure through a vent opening screen 46, the tortuous path would prevent entry into water tank 60. Because vent structure 10 significantly increases the difficulty of introducing an unwanted substance into water tank 60 by a trespasser, a trespasser may be inclined to apply more extreme measures with the use of, for example, a blow torch, explosives, or other destructive instruments. These however are impractical and are likely to draw the attention of law enforcement or other security forces.

While the invention has been particularly shown and described with reference to a preferred embodiment, it will be understood by those skilled in the art that various changes in form and detail may be made therein without departing from the spirit and scope of the invention.

1. A vent structure for deterring intruder access to a storage tank, comprising:
a bottom plate for connection to the storage tank wherein the bottom plate has a tank opening to allow gaseous flow between an atmosphere in the storage tank and an atmosphere within the vent structure;
a cover affixed above and to the bottom plate thereby forming the vent structure housing;
a vent opening formed through the bottom plate to allow gaseous flow between the vent structure's atmosphere and an ambient atmosphere surrounding the storage tank; and
a tortuous pathway disposed between the vent opening and the tank opening within the vent structure thereby allowing gaseous communication between the storage tank atmosphere and the ambient atmosphere surrounding the storage tank.

2. The vent structure of claim 1 wherein the tortuous pathway further comprises a plurality of baffles having at least one baffle extend upward from the bottom plate toward the cover and at least one baffle depend downward from the cover toward the bottom plate.

3. The vent structure of claim 2 wherein the tortuous pathway is formed by a first baffle extending upward from the bottom plate, a second baffle depending downward from the cover toward the bottom plate, and a third baffle extending upward from the bottom plate.

4. The vent structure of claim 1 wherein the vent opening is covered with a fine screen mesh.

5. The vent structure of claim 3 wherein the vent opening further comprises a plurality of openings disposed between the peripheral edge of the bottom plate and the first baffle.

6. The vent structure of claim 1 further comprising a flange affixed to a central portion of the bottom plate about the tank opening.

7. The vent structure of claim 6 wherein the tank opening is covered with a fine screen mesh.

8. The vent structure of claim 2 wherein the tank opening is disposed centrally within the bottom plate and is encompassed by the third baffle.

9. The vent structure of claim 1 further comprising one or more support columns positioned within the vent structure between the vent opening and the tank opening, each support column extending between the cover and the bottom plate.

10. The vent structure of claim 9 wherein at least one of support columns has a terminal end that facilitates the locking of the cover to the bottom plate.

11. The vent structure of claim 10 wherein the terminal end is received and passed through a receptacle in the vent structure to protrude through to an exterior portion of the vent structure, whereby a locking mechanism may be selectively affixed to the protruding terminal end.

12. The vent structure of claim 11 wherein a guard is affixed about the receptacle in the vent structure on an exterior portion thereof for protecting the locking mechanism.

13. The vent structure of claim 12 wherein each support column adapted for receiving a locking mechanism depends from the cover toward the receptacle in the bottom plate, the guard extends outward from the bottom plate to form a barrier around the locking mechanism.

14. The vent structure of claim 2 wherein the vent structure is cylindrical such that the baffles form concentric rings about the tank opening.

15. The vent structure of claim 1 wherein a central portion of the bottom plate is affixed to a flange for attachment to the storage tank.

16. The vent structure of claim 1 wherein the storage tank is for storing water.

17. A vent structure for deterring intruder access to a water storage tank, comprising:
a bottom plate having a flange affixed about a tank opening formed within the bottom plate to allow gaseous flow between an atmosphere in the water storage tank and an atmosphere within the vent structure when connected to the water storage tank;
a cover affixed above and to the bottom plate thereby forming the vent structure housing;
a vent openings formed through the bottom plate to allow gaseous flow between the vent structure's atmosphere and an ambient atmosphere surrounding the water storage tank; and
a tortuous pathway within the vent structure disposed between the vent opening and the tank opening to allow gaseous communication between the water storage tank atmosphere and the ambient atmosphere surrounding the storage tank, further the tortuous pathway being formed by a plurality of baffles having at least one baffle extend upward from the bottom plate toward the cover and at least one baffle depend downward from the cover toward the bottom plate.

18. The vent structure of claim 17 further comprising one or more support columns positioned within the vent structure between the vent opening and the tank opening, each support column extending between the cover and the bottom plate wherein at least one of support columns has a terminal end that is received and passed through a receptacle in the vent structure to protrude through to an exterior portion of the vent structure whereby a locking mechanism may be selectively affixed to the protruding terminal end.

19. The vent structure of claim 18 wherein each support column adapted for receiving a locking mechanism depends from the cover toward the receptacle in the bottom plate, a guard for protecting the locking mechanism extends outward from the bottom plate to form a barrier around the locking mechanism.

20. A system for protecting water within a water storage tank from an intruder using the vent structure of claim 17 comprising affixing the vent structure to the water storage tank atmospheric vent.
